(19) United States
(12) Patent Application Publication
(10) Pub. No.: US 2002/0102882 A1
(43) Pub. Date: Aug. 1, 2002

(54) Card connector device having a metal cover provided with elastic pieces for pressing a card

(75) Inventor: Masanobu Tanaka, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/038,123

(22) Filed: Jan. 2, 2002

(30) Foreign Application Priority Data
Jan. 26, 2001 (JP) 2001-017857

(51) Int. Cl. H01R 24/00

(52) U.S. Cl. 439/630

(57) ABSTRACT

A card connector device comprises a frame 2 having an open upper face and an insertion slot formed at one end portion thereof, into which a card is inserted, a metal cover 3 installed on the frame 2, and terminals 5 to be connected to contacts 24 provided at a bottom face of the card 21 while being supported by the other end portion of the frame 2. Portions of an upper plate 7 of the cover 3 that covers the open upper face of the frame 2 are cut and bent toward the inside of the open upper face so as to form first and second elastic pieces 12 and 13 for pressing an upper face of the card 21 to press the contacts 24 in a direction in which the contacts 24 contact with the terminals 5. Respective one end portions of the first and second elastic pieces at the side of the insertion slot 4 are supported by the upper plate 7 of the cover 3, and their other end portions extend, while gradually parting from each other, toward the support portions of the terminals 5 of the frame 2.

### BACKGROUND OF THE INVENTION

1. Field of the Invention

The present invention relates to a card connector device to be mounted on equipment in which a card is inserted and removed.

2. Description of the Related Art

FIG. 14 illustrates a conventional card connector device. This card connector device, or a card connector device 31, is constituted such that a cover 33 made of a metal planar plate is mounted on a frame 32 of a box shape having an open upper face so as to cover the open upper face, an insertion slot 34 is formed at one end portion of the frame 32, a plurality of terminals 35 are supported by the other end portion of the frame 32 with their tip portions being positioned within the frame 32, and rear end portions of the terminals 35 project from the other end portion of the frame 32.

Further, a hole portion 36 is formed at the cover 33 such that an upper plate of the cover 33 is cut out in a rectangular shape leaving a pair of projection pieces uncut. The pair of the projection pieces are bent toward the inside of the open upper face of the frame 32 to form first and second elastic pieces 37 and 38.

The card connector device 31 is mounted on a circuit board (not shown) and is used with the rear end portions of the plurality of the terminals 35 being soldered to a wiring pattern of the circuit board. An upper face of a card (not shown) inserted from the insertion slot 34 is pressed by the first and second elastic pieces 37 and 38 to press contacts provided on a bottom face of the card against the tip portions of the plurality of the terminals 35 as well as against a reference face of the frame. In this way, the contacts of the card and the wiring pattern of the circuit board are electrically connected through the plurality of the terminals 35, so that information is recorded on or reproduced from the card.

Further, with the card connector device 31, in order to prevent damage, such as scratches, on the card caused when it is slid in insertion and removal operation with the first and second elastic pieces 37 and 38, a spring constant of the first and second elastic pieces 37 and 38 has been set at a magnitude that is necessary and sufficient to maintain the connection between the plurality of terminals 35 and the contacts of the card without giving damage to the card. This was achieved with a dimension L1 of the elastic piece adopted long in an insertion direction (direction of arrow A) of the card.

However, in the card connector device 31 described above, the hole portion 36 must be made large in size in the insertion direction (direction of arrow A) of the card in order to secure the length dimension L1 of the first and second elastic pieces 37 and 38 long. This resulted in an inconvenience, such as lack of rigidity, or strength, of the cover 33, causing the cover 33 to be deformed when external force such as bending force or torsion is applied to the cover 33. In such a case, the first and second elastic pieces 37 and 38 cannot press the upper face of the card with a predetermined pressing force.

### SUMMARY OF THE INVENTION

The present invention has been made in view of the circumstances in the prior art described above. An object of the invention is to provide a card connector device which can enhance rigidity of a cover and can press contacts of a card against terminals to maintain the connections between them.

To achieve the object described above, in accordance with the invention, a card connector device comprises: a frame having an open upper face and an insertion slot formed at one end portion thereof, into which a card is inserted; a metal cover mounted on the frame; and terminals supported by the other end portion of the frame, the terminals being to be connected to contacts provided on a bottom face of the card. In this constitution, portions of upper plate of the cover covering the open upper face of the frame are cut and bent toward the inside of the open upper face of the frame to form first and second elastic pieces, which press an upper face of the card to press the contacts in a direction in which the contacts contact with the terminals. Furthermore, respective one end portions of the first and second elastic pieces at a side of the insertion slot are supported by the upper plate of the cover, and respective other end portions of the pieces extend, while gradually parting from each other, toward support portions of the terminals of the frame, so as to form a space between the other end portions of the first and the second elastic pieces wider than a space between the one end portions of the first and the second elastic pieces.

Further, in the constitution described above, the first and second elastic pieces are disposed on the upper plate of the cover at its one side portion and the other side portion, respectively. A center portion of the upper plate of the cover is cut and bent toward the inside of the open upper face of the frame to provide a third elastic piece at the cover. The third elastic piece presses a portion on an upper face of the card corresponding to a portion near the contacts to press the contacts against the terminals.

Also in the constitution above, the third elastic piece comprises a pressing portion, provided at its center portion, for pressing the upper face of the card, and a pair of elastic arm portions continuously formed at both sides of the pressing portion. Here the third elastic piece is supported by the upper plate of the cover at the pair of the elastic arm portions.

Further, in the constitution described above, a first cutaway portion and a second cutaway portion are formed on the card at one side portion thereof and the other side portion thereof, respectively, while being displaced from each other in an insertion direction of the card. The first and second elastic pieces are arranged at positions, which correspond to the cutaway portions, displaced from each other so that the first and second elastic portions press the both side portions of the upper face of the card while avoiding the first and second cutaway portions.

Further, in the constitution described above, the first and second elastic pieces press both side portions, between the portions where the terminals and the contacts contact with each other and the first and the second cutaway portions, of the upper face of the card near the first and the second cutaway portions.

Also, in the constitution described above, an indication label is adhered on the upper face of the card, and the first and second elastic pieces press portions other than the indication label on the upper face of the card.

### BRIEF DESCRIPTION OF THE DRAWINGS

In the accompanying drawings:

FIG. 1 is a perspective view of a card connector device according to the invention;

FIG. 2 is a perspective view, seen from a bottom side, of the card connector device according to the invention;

FIG. 3 is a plan view of the card connector device according to the invention;

FIG. 4 is a side view of the card connector device according to the invention;

FIG. 5 is a bottom view of the card connector device according to the invention;

FIG. 6 is a plan view illustrating a card insertion process of the card connector device according to the invention;

FIG. 7 is a plan view showing a state where card insertion into the card connector device according to the invention is completed;

FIG. 8 is a plan view of a cover relating to the card connector device according to the invention;

FIG. 9 is a front view of a cover relating to the card connector device according to the invention;

FIG. 10 is a left-side view of a cover relating to the card connector device according to the invention;

FIG. 11 is a right-side view of a cover relating to the card connector device according to the invention;

FIG. 12 is a plan view of a card used for the card connector device according to the invention;

FIG. 13 is a bottom view of a card used for the card connector device according to the invention; and

FIG. 14 is a plan view of a card connector device of a prior art.

### DETAILED DESCRIPTION OF THE PREFERRED EMBODIMENT

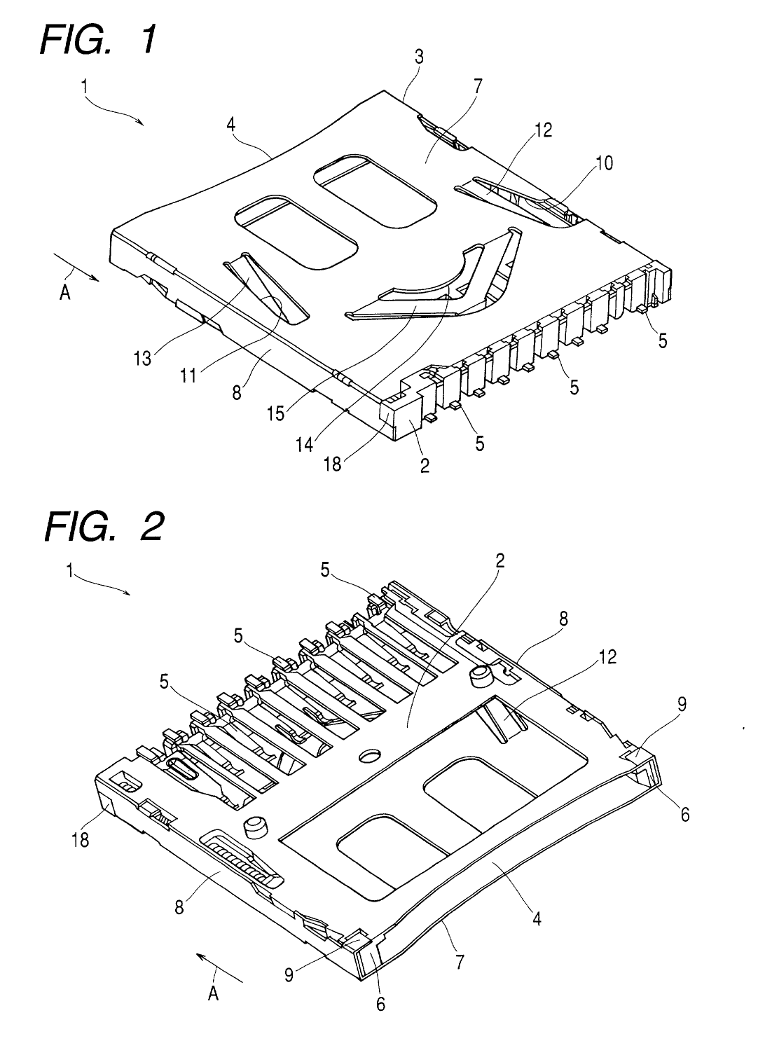

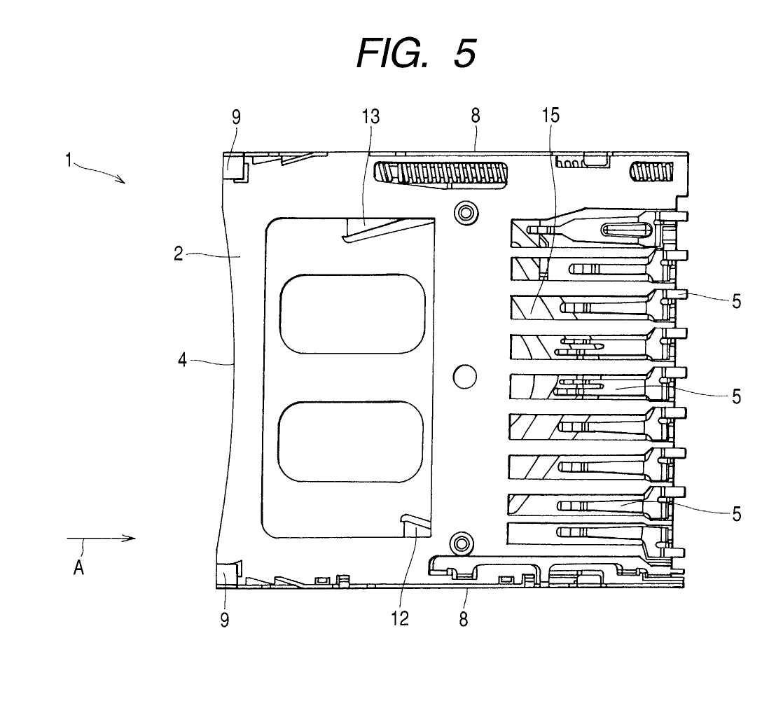

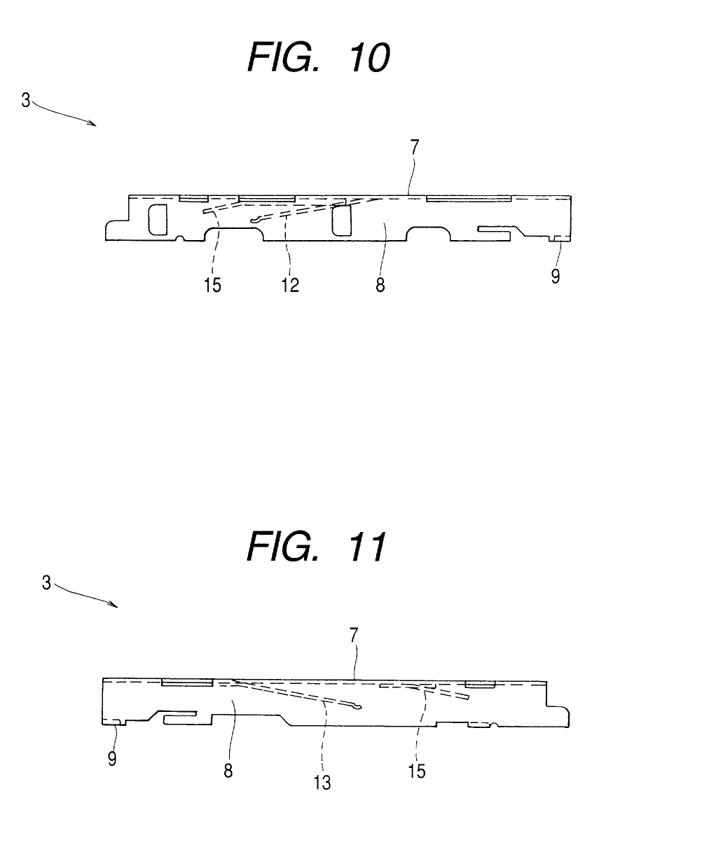

An embodiment of the card connector device according to the invention will be described below referring to FIGS. 1 to 13.

A card connector device 1 is constituted such that a metal cover 3 is mounted on a box shaped frame 2 having an open upper face so as to cover the open upper face of the frame 2.

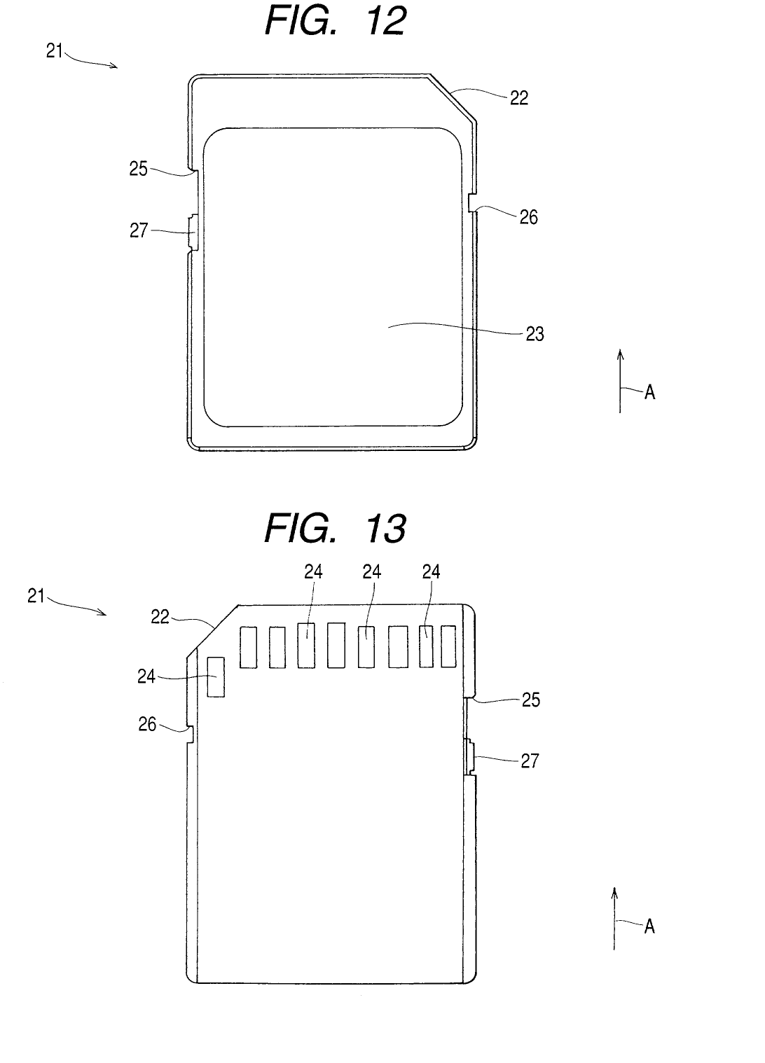

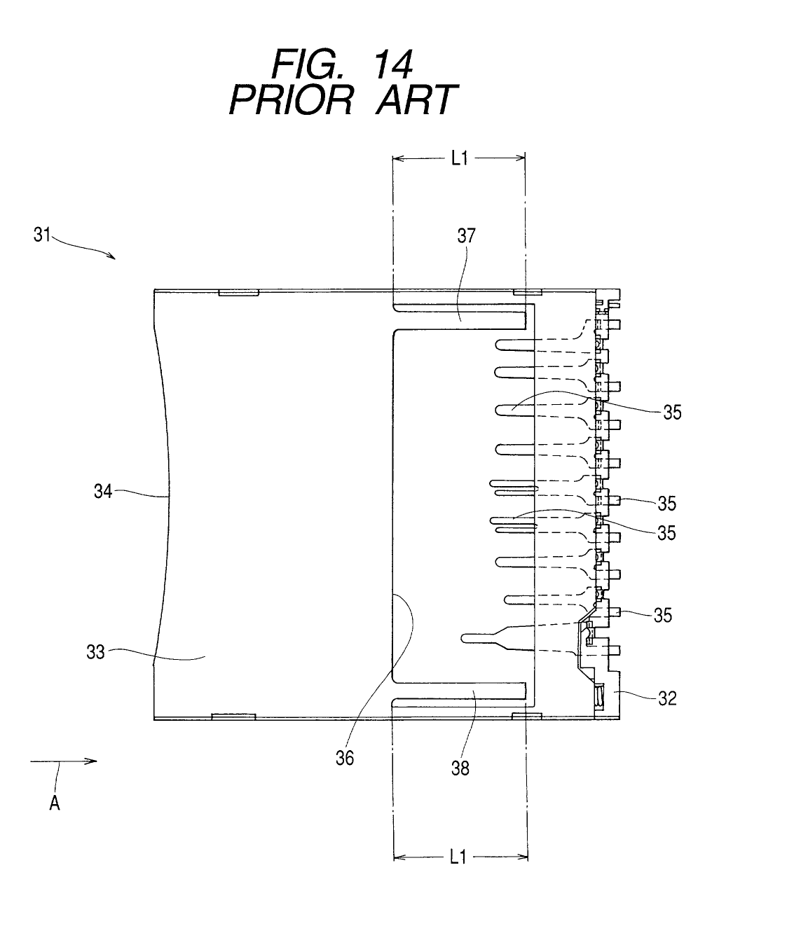

A card 21 used for the card connector device 1 is a type publicly known, and is formed with electronic parts, such as an IC, received in a hard plastic case. In the card 21, as FIG. 12 and 13 show, a taper portion 22 is formed at a corner of its tip end, an indication label 23 in which information such as a product name is written is adhered on its upper face, and a plurality of contacts 24 are arranged side by side at equal space on its bottom face. Further, in the card 21, first and second cutaway portions 25 and 25 are provided at one side portion and the other side portion, respectively, at positions displaced from each other in an insertion direction (direction of arrow A) of the card 21. Also, a knob 27 for inhibiting writing-in of information is slidably mounted within the first cutaway portion 25.

Specific constitutions of the frame 2 and cover 3 composing the card connector device 1 will be described below in sequence.

The frame 2 is formed from an insulation synthetic resin such as PBT (polybutylene terephthalate). An insertion slot 4 is formed at one end portion of the frame 2, and at the other end of the frame 2, a plurality of terminals 5 are supported by insert molding or press-fitting, with tip end portions of the terminals 5 being positioned within the frame 2. Rear end portions of the terminals 5 project from the other end portion of the frame 2. Both side portions of the frame 2 serve as a pair of guide portions 6 that guide the card 21 inserted from the insertion slot 4 to the plurality of the terminals 5.

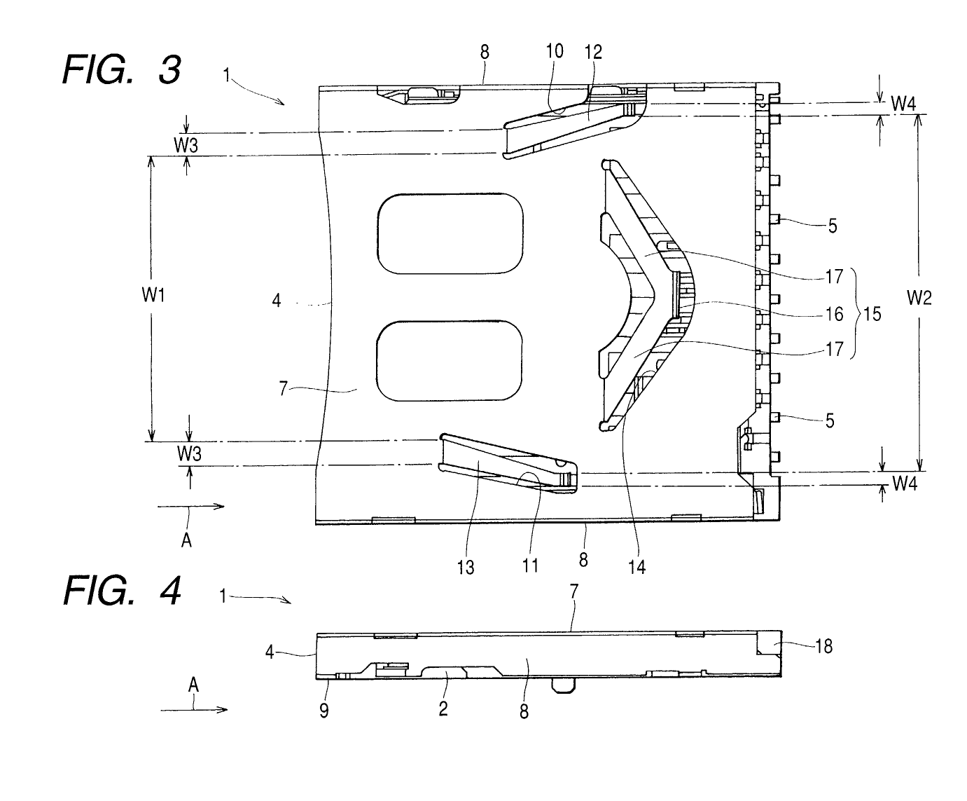

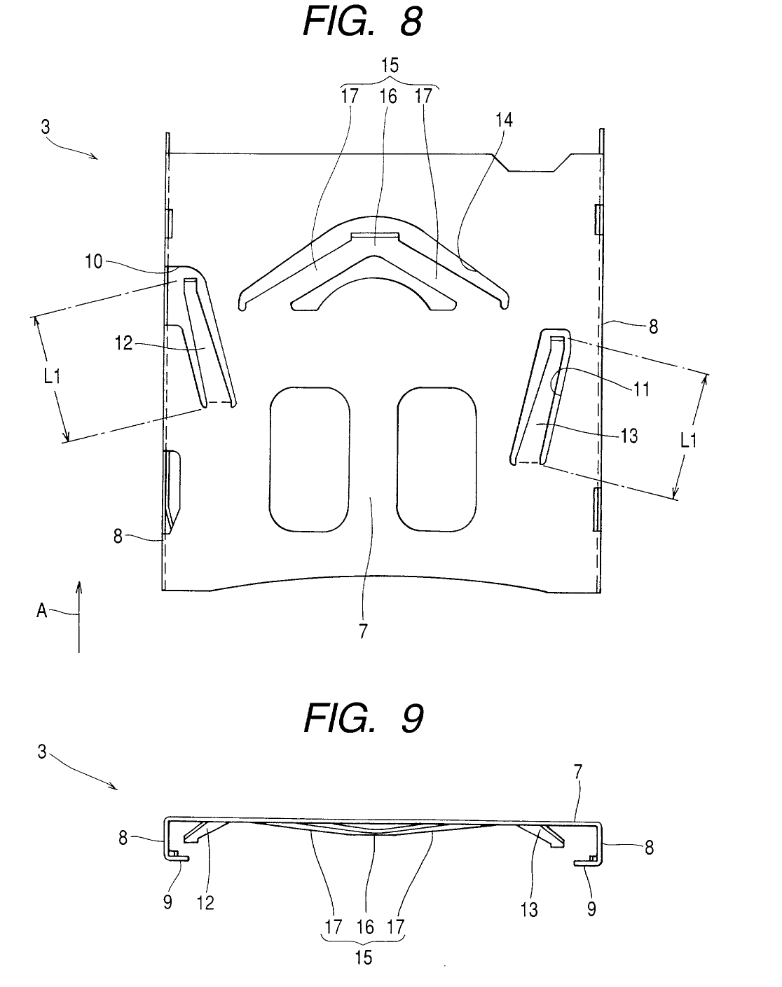

The cover 3 is formed by bending a planar plate of a metal such as stainless steel, as shown in FIGS. 8 to 11. The cover 3 comprises an upper plate 7 and a pair of side plates 8 arranged continuously from the upper plate 7. Securing pieces 9 are integrally formed at one end portion of the pair of side plates 8, while at the same time both side portions of the upper plate 7 are cut out, leaving respective projection pieces uncut, to form first and second hole portions 10 and 11. The pair of projection pieces are bent downwardly to form first and second elastic pieces 12 and 13. Further, the first elastic piece 12 and the second elastic piece 13 are disposed at one side portion and the other side portion of the upper plate 7, respectively. As shown in FIG. 3, in comparison with space W1 of one end portions of the first and second elastic pieces 12 and 13 supported by the upper plate 7, space W2 of the other end portions of the first and second elastic pieces 12 and 13 is formed wider.

A center portion of the upper plate 7 is cut out leaving a projection piece uncut to form a third hole portion 14, and the projection piece is downwardly bent to form a third elastic piece 15. The third elastic piece 15 comprises a pressing portion 16 provided at its center portion and a pair of elastic arm portions 17 continuously formed at both sides of the pressing portion 16, and is supported at the upper plate 7 by the pair of elastic arms portions 17.

The cover 3 is mounted on the frame 2 in such a way that, as shown in FIGS. 1 to 5, the securing pieces 9 are secured to a bottom face of the frame 2 and the other end portions of both the side plates 8 are secured to securing projections 18 of the frame 2. The first and second elastic pieces 12 and 13 are disposed at positions displaced from each other in an insertion direction (direction of arrow A) of the card 21, and are formed such that, with the respective one end portion at the side of the insertion slot 4 being supported by the upper plate 7 of the cover 3, the respective other end portions extend, while gradually parting from each other, toward support portions of the terminals 5 of the frame 2.

The card connector device 1 constituted as described above is mounted on a circuit board (not shown) and used with rear end portions of the plurality of terminals 5 being soldered to a wiring pattern of the circuit board. When the card 21 is inserted into the insertion slot 4 first with the tip end portion at which the contacts 24 are formed, the card 21 is led into the frame 2 along the insertion direction (direction of arrow A) of the card 21 as guided by a pair of guide portions 6 of the frame 2. Then, the tip end portion of the card 21 contacts with the other end portion of the first elastic piece 12 while at the same time the taper portion 22 of the card 21 contacts with the other end portion of the second elastic piece 13.

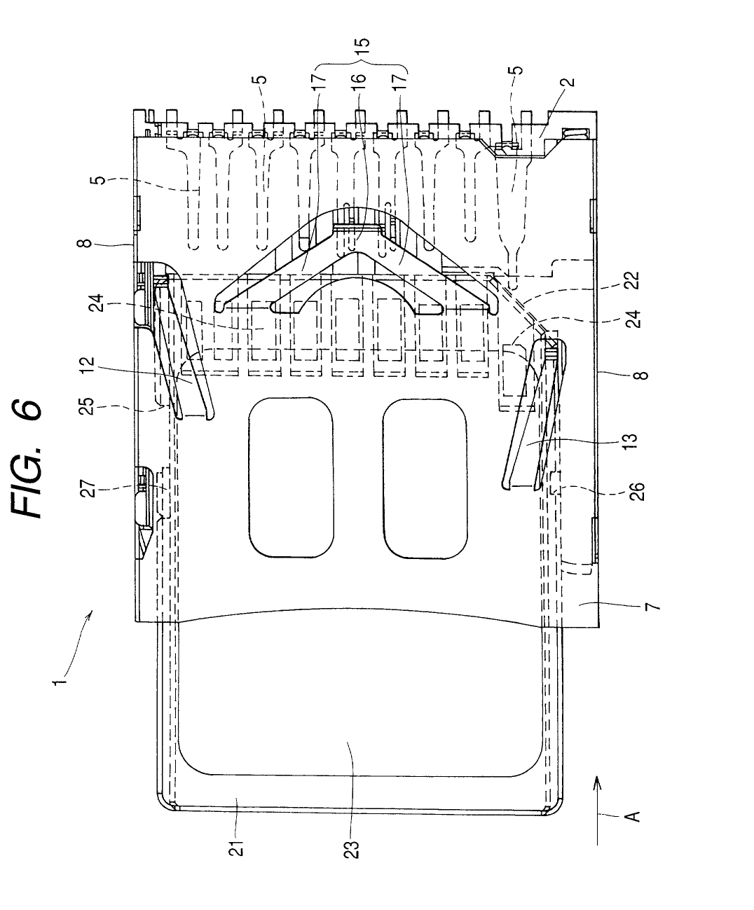

When the card 21 is further inserted into the inside of the frame 2, the first and second elastic pieces 12 and 13 are pushed upward, against their own elasticity, with their one end portions serving as fulcrums. Then, as FIG. 6 shows, the other end portions of the first and second elastic portions 12 and 13 run on the upper face of the card 21. The card 21 is further led into the inside of the frame 2 while allowing the other end portions of the first and second elastic pieces 12 and 13 to slide on both the side portions of the upper face of the card 21. Thus the tip end portion of the card 21 contacts with the pressing portion 16 of the third elastic piece 15.

When the card 21 is further inserted into the inside toward a deepest position in the frame 2, the third elastic piece 15 is pushed upward against its own elasticity with points where the pair of the elastic arm portions 17 and the upper plate 7 of the cover 3 are connected serving as fulcrums. Then the pressing portion 16 of the third elastic piece 15 runs on the upper face of the card 21, and the card 21 is further led to the inside of the frame 2 while allowing the pressing portion 16 of the third elastic piece 15 to slide on the upper face of the card 21.

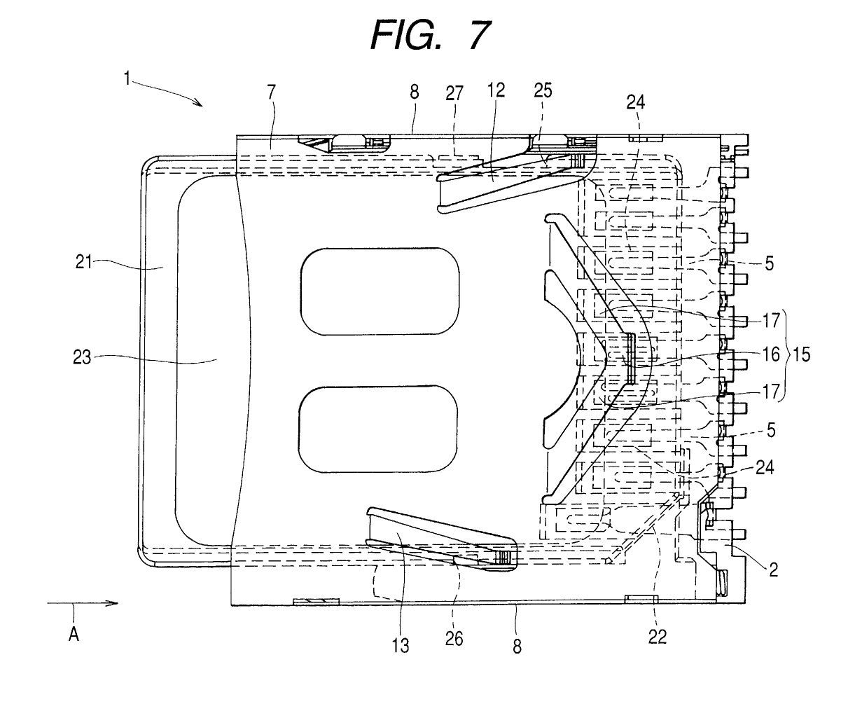

Further, as FIG. 7 shows, when the card 21 reaches the deepest position in the frame 2, the pressing portion 16 of the third elastic piece 15 positions at a portion on the upper face of the card 21 corresponding to a portion of the contacts 24. Therefore, the third elastic piece 15 presses with its pressing portion 16 the portion on the upper face of the card 21 corresponding to the portion of the contacts 24 to press the contacts 24 against the terminals 5. Also at the same time, the first and second elastic pieces 12 and 13 press portions, located farther toward the insertion slot 4 than the pressing portion 16 of the third elastic piece 15, on the upper face of the card 21. Or the first and second elastic pieces 12 and 13 press portions between the portions where the terminals 5 and the contacts 24 contact with each other and the first and second cutaway portions 25 and 26, at both sides of the upper face of the card 21 near the first and the second cutaway portions 25 and 26. Thus the contacts 24 are pressed to a direction where they contact with the terminals 5, so that the upper face of the card 21 is pressed by different three points of the first, second, and the third elastic pieces 12, 13, and 15. In this way, each of the contacts 24 is connected to each of the terminals 5.

Thus, in the card connector device 1, the contacts 24 of the card 21 and a wiring pattern of the circuit board are electrically connected through the terminal 5. Consequently, in this state, recording and reproducing signals can be transmitted and received between the card 21 and the circuit board so that recording or reproducing of information to or from the card 21 is carried out.

In the card connector device 1, the first and second elastic pieces 12 and 13 are formed such that, with their respective one end portion at the side of the insertion slot 4 being supported by the upper plate 7 of the cover 3, their respective other end portions extend, while gradually parting from each other, toward the support portions of the terminals 5 of the frame 2. Consequently, in comparison with space W1 between the one end portions of the first and the second elastic pieces 12 and 13, space W2 between the other end portions of the first and the second elastic pieces 12 and 13 is formed wider. Therefore, as FIG. 8 shows, the sizes of the first and second hole portions 10 and 11 in the insertion direction (direction of arrow A) of the card 21 can be formed small while keeping the length dimension L1 of the first and second elastic pieces 12 and 13 same as that adopted in the prior art. This improves rigidity of the cover 3, making it possible to prevent deformation of the cover 3 under external force such as bending force or torsion.

Further, the one end portions of the first and second elastic pieces 12 and 13, located at the side of the insertion slot 4 and supported by the upper plate 7 of the cover 3, can be disposed more inward than the other end portions thereof. Therefore, as FIG. 3 shows, a width W3 between the one end portions of first and second elastic pieces 12 and 13 can be set wider than a width W4 between their other end portions. This can enhance elastic limit (strength) of the elastic pieces 12 and 13 themselves as well as that of the cover 3.

Further, the cover 3 is provided with the third elastic piece 15 for pressing a portion, corresponding to a portion of the contacts 24, of the upper face of the card 21. Thus, because the third elastic piece 15 and the first and second elastic pieces 12 and 13 jointly press the upper face of the card 21 to press the contacts 24 in the direction where they contact with the terminals 5, connections between the contacts 24 and the terminals 5 are secured.

Further, a length dimension of the pair of elastic arm portions 17 of the third elastic piece 15 can be set long without forming a third hole portion 14 large in the insertion direction (direction of arrow A) of the card 21. Consequently, acting force of the third elastic piece 15 can be set sufficiently large while limiting a magnitude of its spring constant and yet keeping rigidity of the cover 3.

Further, the first and second elastic pieces 12 and 13 are disposed at positions displaced from each other in the insertion direction (direction of arrow A) of the card 21 so that they press the upper face of the card 21 avoiding the cutaway portions 25 and 26. Therefore, the first and second elastic pieces 12 and 13 press both side portions, between portions where the terminals 5 and the contacts 24 contact with each other and the first and second cutaway portions 25 and 26, of the upper face of the card 21 near the first and second cutaway portions 25 and 26. Thus, the other end portions of first and second elastic pieces 12 and 13 can, in cooperation with the third elastic piece 15, press different three points on the upper face of the card 21 without dropping into the first and second cutaway portions 25 and 26. In this way, the contacts 24 of the card 21 are securely pressed against the terminals 5.

Further, the first and second elastic pieces 12 and 13 press the upper side of the card 21 other than a portion where the indication label 23 is adhered. This prevents peeling off of the indication label 23 or fading of indications on the label 23 caused by sliding on the card 21 of the first and second elastic pieces 12 and 13 at the time of the insertion and removal of the card 21.

The present invention is realized as the embodiment discussed above, providing effect that will be described below.

A card connector device according to the invention comprises: a frame having an open upper face and an insertion slot formed at one end portion thereof, into which a card is inserted; a metal cover mounted on the frame; and terminals supported by the other end portion of the frame, the terminals being to be connected to contacts provided on a bottom face of the card. In this constitution, portions of upper plate of the cover covering the open upper face of the frame are cut and bent toward the inside of the open upper face of the frame to form first and second elastic pieces, which press an upper face of the card to press the contacts in a direction in which the contacts contact with the terminals. Furthermore, respective one end portions of the first and second elastic pieces at a side of the insertion slot are supported by the upper plate of the cover, and respective other end portions of the pieces extend, while gradually parting from each other, toward support portions of the terminals of the frame, so as to form a space between the other end portions of the first and the second elastic pieces wider than a space between the one end portions of the first and the second elastic pieces. The constitution described above enhances rigidity of the cover, prevents deformation of the cover subjected to external force such as bending force or torsion, and presses the contacts of the card against the terminals, without giving any damage to the card, to maintain connections between them.

Further, the first and second elastic pieces are disposed on the upper plate of the cover at its one side portion and the other side portion, respectively. A center portion of the upper plate of the cover is cut and bent toward the inside of the open upper face of the frame to provide a third elastic piece at the cover. The third elastic piece presses a portion on an upper face of the card corresponding to a portion near the contacts to press the contacts against the terminals. Therefore, connections between the contacts and the terminals can be secured.

Further, the third elastic piece comprises a pressing portion, provided at its center portion, for pressing the upper face of the card, and a pair of elastic arm portions continuously formed at both sides of the pressing portion. Here the third elastic piece is supported by the upper plate of the cover at the pair of the elastic arm portions. Consequently, the third elastic piece can have sufficiently large acting force while limiting a magnitude of its spring constant and yet keeping its rigidity.

Further, in the card, a first cutaway portion and a second cutaway portion are formed on the card at one side portion thereof and the other side portion thereof, respectively, while being displaced from each other in an insertion direction of the card. The first and second elastic pieces are arranged at positions, which correspond to the cutaway portions, displaced from each other so that the first and second elastic portions press the both side portions of the upper face of the card while avoiding the first and second cutaway portions. Thus the first and second elastic pieces can securely press the contacts of the card against the terminals without dropping in the first and second cutaway portions.

Further, the first and second elastic pieces press both side portions, between the portions where the terminals and the contacts contact with each other and the first and the second cutaway portions, of the upper face of the card near the first and the second cutaway portions. Therefore, the first and second elastic pieces press, in cooperation with the third elastic piece described above, three different points on the upper face of the card to securely press the contacts of the card against the terminals.

Further, an indication label is adhered on the upper face of the card, and the first and second elastic pieces press portions other than the indication label on the upper face of the card. This prevents peeling off of the label or fading of indications on the label caused by sliding on the card of the first and second elastic pieces at the time of the insertion and removal of the card 21.

What is claimed is:

1. A card connector device comprising:
a frame having an open upper face and an insertion slot formed at one end portion thereof, into which a card is inserted;
a metal cover mounted on the frame; and
terminals supported by the other end portion of said frame, the terminals being to be connected to contacts provided on a bottom face of said card,
wherein portions of upper plate of said cover covering the open upper face of said frame are cut and bent toward inside of the open upper face of said frame to form first and second elastic pieces, which press an upper face of said card to press said contacts in a direction in which said contacts contact with said terminals, and
respective one end portions of the first and second elastic pieces at a side of said insertion slot are supported by the upper plate of said cover, and respective other end portions of the pieces extend, while gradually parting from each other, toward support portions of said terminals of said frame, so as to form a space between the other end portions of said first and second elastic pieces wider than a space between the one end portions of said first and second elastic pieces.

2. The card connector device according to claim 1, wherein said first and second elastic pieces are disposed on the upper plate of said cover at its one side portion and the other side portion, respectively,
a center portion of the upper plate of said cover is cut and bent toward the inside of the open upper face of said frame to provide a third elastic piece at said cover, and
the third elastic piece presses a portion on the upper face of said card corresponding to a portion near the contacts to press said contacts against said terminals.

3. The card connector device according to claim 2, wherein said third elastic piece comprises a pressing portion, provided at its center portion, for pressing the upper face of said card, and a pair of elastic arm portions continuously formed at both sides of the pressing portion, and said third elastic piece is supported by the upper plate of said cover at the pair of the elastic arm portions.

4. The card connector device according to claim 1, wherein a first cutaway portion and a second cutaway portion are formed on said card at one side portion thereof and the other side portion thereof, respectively, while being displaced from each other toward an insertion direction of said card, and said first and second elastic pieces are arranged at positions, which correspond to the cutaway portions, displaced from each other so that said first and second elastic portions press the both side portions of the upper face of said card while avoiding said first and second cutaway portions.

5. The card connector device according to claim 4, wherein said first and second elastic pieces press both side portions, between the portions where said terminals and said contacts contact with each other and said first and the second cutaway portions, of the upper face of said card near said first and the second cutaway portions.

6. The card connector device according to claim 5, wherein an indication label is adhered on the upper face of said card, and said first and second elastic pieces press portions other than said indication label on the upper face of said card.
